(19) United States
(12) Patent Application Publication
(10) Pub. No.: US 2008/0002425 A1
(43) Pub. Date: Jan. 3, 2008

(54) Lighting Device With Fluid Wave Projection

(76) Inventor: Junhon Lin, Rowland Heights, CA (US)

Correspondence Address: LIN & ASSOCIATES INTELLECTUAL PROPERTY, INC., P.O. BOX 2339, SARATOGA, CA, 95070-0339, US

(21) Appl. No.: 11/428,546

(22) Filed: Jul. 3, 2006

(51) Int. Cl. A01K 63/06

(52) U.S. Cl. 362/562

(57) ABSTRACT

A lighting device capable of producing fluid wave projection is disclosed herein. The lighting device includes a lamp support having a bearing member, a wave-generating apparatus, and at least one light source. The wave-generating apparatus is installed on the bearing member and includes a translucent tank body within which a translucent fluid is contained as well as a wave-generating unit immersed in the fluid and installed in the tank body. The light sources are installed at one side of the wave-generating apparatus so that the light emitted therefrom travels through the wave-generating apparatus and produces wave projection.

### BACKGROUND OF THE INVENTION

1. Field of the Invention

The present invention relates to a lighting device, and in particular to a lighting device which is capable of producing fluid wave projections.

2. The Prior Arts

The primary objective of a common lighting device is to provide illumination. Such a type of lighting device usually comprises a lamp support for the installation of a light bulb, which is covered with a lampshade. The disposition of the lampshade varies depending on the functions of lighting. For example, when stronger light is required for the purpose of reading or doing a task, the light reflected off from the lampshade or emitted from the light bulb are directed to the object to be lighted. On the other hand, in the case of general space illumination, the lampshade may be devised transparent and capable of dispersing the reflected light to enlarge the illuminated area. However, the aforementioned dispositions of lighting devices are to illuminate an object or space in the dark by means of the light emitted from the light bulb. They are monotonous and lack of variegation as far as lighting functions and aesthetics are concerned.

A conventional water lamp has been provided to enhance the aesthetic effect of the regular lighting devices, which utilizes the transparency characteristic of water to produce various shades of brightness of waves. In the conventional water lamp, a glass lampshade that allows water to flow down along its outer shell covers the light bulb. The light emitted from the light bulb projects on the lampshade to produce a projection with various brightness of wave mark. However, the water lamp employs a water circulation device in which water flows through a specially structured glass lampshade to a container, and then pumped up to the top brim of the glass lampshade by a submersible motor to complete a circulation. Such a design results in a complicated structure and thus a higher manufacturing cost. Furthermore, according to the prior invention, the water circulates in open space, which makes it liable to be contaminated by air or dust, or to spill out from the surface of the lampshade and sprinkle on objects located in its vicinity. Therefore, the lighting device requires constant cleaning and maintenance, and causes inconvenience when in use.

### SUMMARY OF THE INVENTION

To enhance the lighting effect of common lighting devices, as well as to improve the structural disadvantages and projection effect associated with the conventional water lamp, a lighting device is provided according to the present invention. The lighting device generates a variety of wave projections by a simple wave-generating apparatus to improve the variegation and aesthetics of the lighting effect. It broadens the application of conventional lighting, and at the same time is easy to assemble and maintain.

The lighting device with fluid wave projection according to the present invention comprises a lamp support having a bearing member, a wave-generating apparatus, and at least one light source. The wave-generating apparatus is installed on the bearing member, and includes a translucent tank body that contains a translucent fluid as well as a wave-generating unit immersed in the fluid. The light sources are installed at one side of the wave-generating apparatus so that the light emitted therefrom travels through the wave-generating apparatus and produces wave projections. The wave-generating unit may be a pump or a vibrator, but not limited thereto. The tank body includes a cover and a bottom plate, either of which may be a plane, a convex dome, or a concave dome in structure, but not limited thereto.

According to the present invention, simply with a sealed tank in conjunction with a fluid and a wave-generating unit, the wave-generating apparatus is capable of generating waves in the tank body. In this respect, the present invention is structurally simpler than prior inventions. Besides, the wave-generating apparatus according to the present invention circulates or vibrates the fluid in a closed space to generate different waves or variegated wave marks which are circumfused by the light source to produce a variety of wave projections at the other side of the light source. In this respect, the present invention not only increases the lighting variation, but also enhances the lighting aesthetics. Furthermore, the closed wave-generating space prevents the fluid from spilling out and contaminated by air or dust. It simplifies the cleaning and maintenance required.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of a preferred embodiment in accordance with the present invention;

FIG. 2 is an exploded schematic view of the preferred embodiment in accordance with the present invention;

FIG. 3 is a cross-sectional view of a wave-generating apparatus in accordance with a preferred embodiment of the present invention;

FIG. 4 is a schematic view of the projection by the preferred embodiment in accordance with the present invention; and

FIG. 5 is a schematic view of a second embodiment in accordance with the present invention.

### DETAILED DESCRIPTION OF THE PREFERRED EMBODIMENT

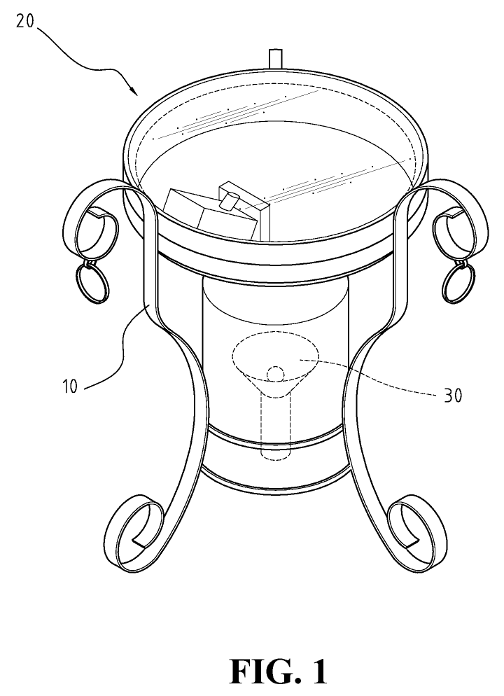

With reference to FIG. 1, a lighting device with fluid wave projection according to the present invention comprises a lamp support 10, a wave-generating apparatus 20 and a light source 30. The wave-generating apparatus 20 is installed on top of the lamp support 10, and the light source 30 is installed below the wave-generating apparatus 20. The light emitted by the light source 30 travels through the wave-generating apparatus 20 to produce a wave-like projection at the other side of the wave-generating apparatus 20.

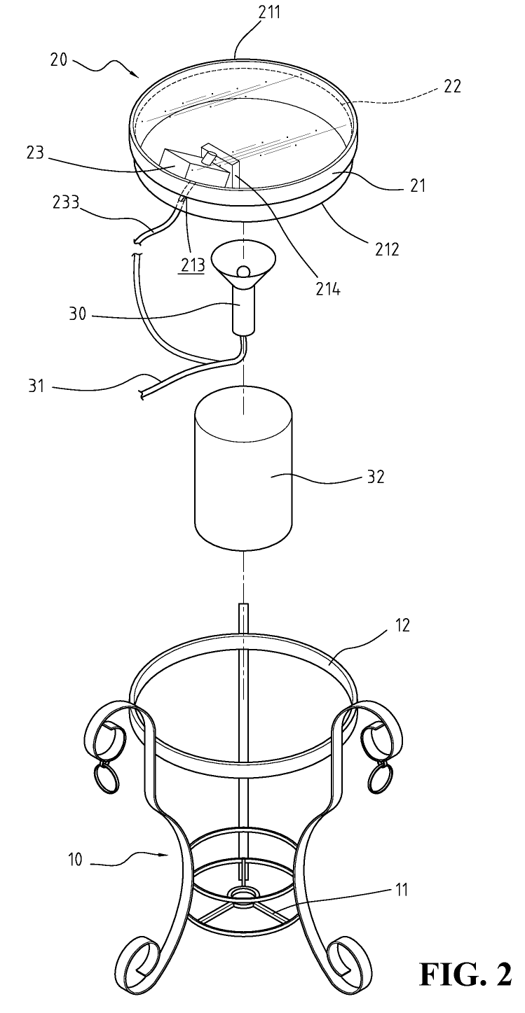

FIG. 2 is an exploded schematic view of the preferred embodiment of the present invention. Referring to FIGS. 1 and 2, the structure of the lamp support 10 here serves only for illustrative purposes and is not limited thereto. The lamp support 10 includes a fixing member 11 for the installation of the light source 30 and a bearing member 12 for the installation of the wave-generating apparatus 20.

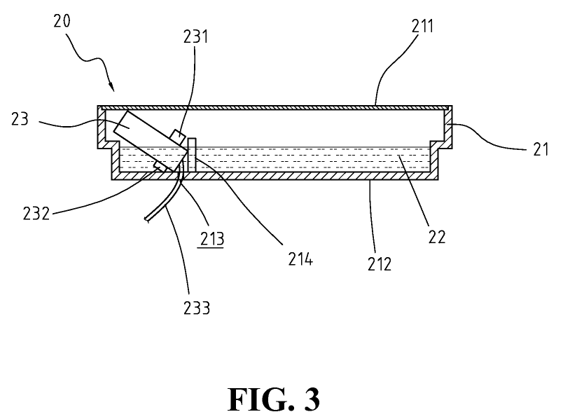

FIG. 3 is a cross-sectional schematic view of a wave-generating apparatus in accordance with a preferred embodiment of the present invention. With reference to FIG. 3, the wave-generating apparatus 20 includes a tank body 21, a fluid 22 and a pump 23. The tank body 21 of the preferred embodiment is a cylinder, but its shape is not limited thereto. It may be a cuboid or any other shape depending on the shape of the bearing member 12. The tank body 21 includes a cover 211 and a bottom plate 212. The cover 211 seals the tank body after the tank body 21 is filled with the fluid 22. The cover 211 and the bottom plate 212 are made of translucent material, such as glass, acrylic, or other similar materials, so that the light emitted by the light source 30 may pass through. The structures of the cover 211 and the bottom plate 212 may be any combination of a plane, a convex dome or a concave dome, but not limited thereto. The dome-like structure creates unique light concentration or dispersion, which variegates the projection effect.

The fluid 22 is to be filled into the tank body 21. The minimum amount thereof is one that allows the pump 23 to draw in and discharge water, and the maximum amount thereof is one that may fill the whole tank body 21. The fluid 22 is translucent, and may be water or fluid of other density. It may be colorless or in any color.

The preferred embodiment of the present invention utilizes the pump 23 as the wave-generating unit, but not limited thereto. The pump 23 is a conventional device commonly employed in water gardening. It includes a water outlet 231 and a water inlet 232, and is powered with electricity by a first power supply cord 233. Often a sucker (not shown in the drawing) is disposed at the water inlet end thereof to fasten the pump 23 to the bottom plate 212. In the present embodiment, a fastening board 214 protrudes upwardly from the bottom plate 212 to fix the pump 23 to one corner of the tank body 21. Besides, a groove (not shown in the drawing) may be formed protruding downwardly from the bottom plate 212 of the tank body 21 to fix the pump 23 in the groove. On the other hand, the first power supply cord 233 connected with the pump 23 may extend outwardly through a through hole 213 formed at the bottom plate 212. The through hole 213 may be sealed with water-proof sealant to prevent the fluid 22 from leaking out and maintain the sealed state of the tank body 21.

There is no specific limitation to the type of light source 30. It may be an incandescent light bulb, a fluorescent tube, a halogen lamp, or a light-emitting diode. The color of the light is not limited to white or yellow; other colors may apply. The number of the light source 30 is not limited, either. It may be single or plural.

Please refer to FIG. 2 again. When assembling the lighting device with fluid wave projection of the present invention, first, the first power supply cord 233, which is connected to the pump 23, is connected with the second power supply cord 31, which is connected to the light source 30. Then the light source 30 and wave-generating apparatus 20 are installed in sequence to the fixing member 11 and the bearing member 12, respectively. Thus the assembly of the lighting device with fluid wave projection is rather simple. A lampshade 32 may be further installed around the light source 30 to enhance the aesthetics of the lighting device and soften the light emitted. The design of the lampshade 32 is not limited to the drawing. It may be varied to fit the lamp support 10 or to fulfill the lighting requirement.

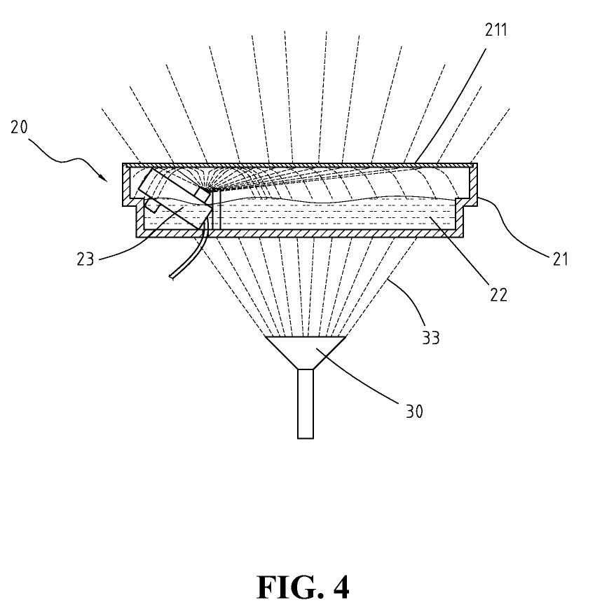

FIG. 4 is a schematic view of the projection by the embodiment of the present invention. When the lighting device with fluid wave projection is assembled, the power supply may be switched on to turn the light source 30 on and actuate the pump 23. In the present embodiment, the fluid 22 fills only part of the tank body. After drawn in, the fluid is discharged toward the cover 211 located at the top of the tank body 21 and forms unique wave marks at the cover 211 before it falls down, which results in the desired irregular variations of wave marks. The light emitted by the light source 30 passes through the irregular wave marks generated by the wave-generating apparatus 20 and forms projection of aforementioned wave marks at the other side. The installation position and discharge direction of the pump 23 is not limited and may be varied depending on the desired effect. The aforementioned wave mark projection may be cast on the wall or on the ceiling to variegate the lighting effect and enhance the uniqueness of the aesthetics. Furthermore, the waves of the fluid 22 are generated in the sealed tank body 21, which overcomes the disadvantage associated with conventional water lamp caused by the fluid circulation in an open environment.

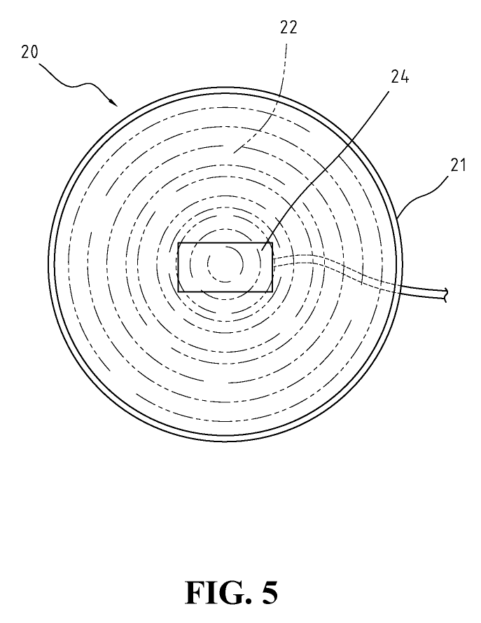

FIG. 5 is a second embodiment of the present invention. Referring to FIG. 5, the wave-generating unit is a vibrator 24 instead of the aforementioned pump 23. The vibrator 24 may be installed at the center of the tank body 21 of the wave-generating apparatus 20, but not limited thereto. The vibrator 24 is capable of generating a predetermined frequency. The vibration thereof enables the fluid 22 to produce concentric ripples with the vibrator 24 as the center. Through the projection of the light source 30, another unique lighting effect is achieved.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A lighting device with fluid wave projection, comprising
a lamp support having a bearing member;
a wave-generating apparatus installed on said bearing member, and comprising a translucent tank body with a translucent fluid contained therein as well as a wave-generating unit immersed in said fluid and installed in said tank body; and
at least one light source installed at one side of said wave-generating apparatus, wherein the light emitted therefrom travels through said wave-generating apparatus to produce wave projections.

2. The lighting device as claimed in claim 1, wherein said wave-generating unit is a pump.

3. The lighting device as claimed in claim 2, wherein said pump draws in said fluid in said tank body and discharges said fluid toward the top surface of said tank body.

4. The lighting device as claimed in claim 1, wherein said wave-generating unit is a vibrator.

5. The lighting device as claimed in claim 1, wherein a fastening board extends from the inner surface of said tank body and fixes said wave-generating unit to said tank body.

6. The lighting device as claimed in claim 1, wherein a groove protrudes outwardly from said tank body and fixes said wave-generating unit to said groove.

7. The lighting device as claimed in claim 1, wherein said tank body includes a cover, which is a flat surface.

8. The lighting device as claimed in claim 1, wherein said tank body includes a cover, which is a convex dome.

9. The lighting device as claimed in claim 1, wherein said tank body includes a cover, which is concave dome.

10. The lighting device as claimed in claim 1, wherein said tank body includes a bottom plate, which is a flat surface.

11. The lighting device as claimed in claim 1, wherein said tank body includes a bottom plate, which is a convex dome.

12. The lighting device as claimed in claim 1, wherein said tank body includes a bottom plate, which is a concave dome.

13. The lighting device as claimed in claim 1, wherein said fluid is colorless.

14. The lighting device as claimed in claim 1, wherein said fluid is colored.

15. The lighting device as claimed in claim 1, wherein a lampshade is further installed around said light sources.
